(19) United States
(12) Patent Application Publication
(10) Pub. No.: US 2024/0394059 A1
(43) Pub. Date: Nov. 28, 2024

(54) SYSTEMS AND METHODS FOR BALANCING COMPUTING RESOURCES

(71) Applicant: HUAWEI TECHNOLOGIES CO., LTD., SHENZHEN (CN)

(72) Inventors: Henry Fangli KAO, Kanata (CA); José Nelson AMARAL, Kanata (CA)

(73) Assignee: HUAWEI TECHNOLOGIES CO., LTD., SHENZHEN (CN)

(21) Appl. No.: 18/368,972

(22) Filed: Sep. 15, 2023

Related U.S. Application Data
(63) Continuation of application No. PCT/CN2023/096221, filed on May 25, 2023.

(51) Int. Cl. G06F 9/30; G06F 9/32

(52) U.S. Cl. CPC G06F 9/30065; G06F 9/325

(57) ABSTRACT

Methods and systems for balancing computing resources is described. According to an aspect, a method for balancing computing resources may be provided. The method includes generating multiple vectorized loops of a scalar code. The method may further include interleaving each of the multiple vectorized loops to generate multiple interleaved vectorized loops. The interleaving may be based on available vector resources. The method may further include interpolating one or more scalar iterations of the scalar loop into each of the multiple interleaved vectorized loops to generate multiple interleaved and scalar interpolated vectorized loops. The method may further include selecting one of the multiple interleaved and scalar interpolated vectorized loops based on a cost mode.

### CROSS-REFERENCE TO RELATED APPLICATIONS

This is the first application filed for the present disclosure.

### TECHNICAL FIELD

The present disclosure pertains to the field of computer performance engineering, and in particular to methods and systems for balancing computing resources, such as processor resources.

### BACKGROUND

The use of computing resources, including processor resources, plays a critical role in modern computing systems. However, it comes with its own set of challenges. One challenge is inefficient resource utilization, where not all available resources are optimally utilized during program execution. This can result in reduced performance and efficiency. Another challenge is overuse of resources, which can lead to processor stalls or contention, causing delays and decreased throughput. High register pressure, caused by the limited number of registers available in a processor, can further complicate resource optimization, as it may result in frequent register spills and reloads, leading to performance degradation.

Moreover, dynamically scheduled out-of-order processors, can pose challenges in managing instruction dependencies and scheduling instructions for execution. Processors with different memory configurations, such as separate memory locations for scalar and vector values, can also add complexity in optimizing data movement between different memory types.

Therefore, there is a need for systems and methods for balancing computing resources that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

Methods and systems for balancing computing resources may be provided. In some aspects, methods and systems relate to scalar interpolation to balance issue-slot utilization of dynamically scheduled processors with vector units. According to an aspect, a method may be provided for balancing computing resources, e.g., processor resources, during static compilation. The method includes generating multiple vectorized loops of a scalar code. The method may further include interpolating one or more scalar iterations of the scalar loop into each of the multiple vectorized loops to generate multiple scalar interpolated vectorized loops. The method may further include selecting one of the multiple scalar interpolated vectorized loops based on a cost model.

The method may further include determining that the scalar loop is legal to vectorize. The method may further include determining that scalar interpolation is legal for each of the multiple vectorized loops. The method may further include, for each of the multiple vectorized loops, determining a number of scalar iterations to interpolate based on the available scalar resources. The one or more scalar iterations interpolated into each of the multiple vectorized loops may be based on the determined number of scalar iterations.

The cost model may be based on heuristics calculated based on number of instructions in each of the multiple interleaved and scalar interpolated vectorized loops. The cost model may be further based on latency of instructions in each of the multiple interleaved and scalar interpolated vectorized loops. The cost model may be further based on instruction-level parallelism (ILP) present in each of the multiple interleaved and scalar interpolated vectorized loops.

The method may further include interleaving one or more of the multiple vectorized loops to generate one or more interleaved vectorized loops, the interleaving being based on available vector resources.

Interpolating one or more scalar iterations of the scalar loop into each of the multiple vectorized loops to generate multiple scalar interpolated vectorized loops further may include interpolating one or more scalar iterations of the scalar loop into each of the one or more interleaved vectorized loops to generate one or more interleaved and scalar interpolated vectorized loops.

Selecting one of the multiple scalar interpolated vectorized loops based on a cost model may include selecting, based on the cost model, one of: the multiple scalar interpolated vectorized loops and the one or more interleaved and scalar interpolated vectorized loops.

According to another aspect, a method may be provided for balancing computing resources, e.g., processor resources, based on feedback or profiling information obtained during program execution. The method includes obtaining a vectorized loop from a program. The method may further include interpolating one or more scalar iterations of the vectorized loop into the vectorized loop to generate a scalar interpolated vectorized loop. Obtaining the vectorized loop from a program comprises vectorizing the program. The program may be a pre-compiled program.

The method may further include determining that scalar interpolation is legal for the vectorized loop. The method may further include obtaining runtime data of the vectorized loop. The obtained runtime data may be performance data indicating resource utilization. The method may further include determining, based on the obtained runtime data, that scalar interpolation is beneficial to the vectorized loop in terms of resource utilization.

Interpolating one or more scalar iterations of the vectorized loop into the vectorized loop may include interpolating based on the obtained runtime data. Interpolating one or more scalar iterations of the vectorized loop into the vectorized loop may include generating one or more equivalent scalar iterations of the vectorized loop. Interpolating one or more scalar iterations of the vectorized loop into the vectorized loop may further include interpolating the one or more of the generated equivalent scalar iterations into the vectorized loop.

The method may further include determining the available scalar resources for scalar interpolation. The method may further include determining a number of scalar iterations to interpolate into the vectorized loop based on one or more of: the obtained runtime data and the available scalar resources. The one or more scalar iterations interpolated into the vectorized loop may be based on the determined number of scalar iterations.

The method may further include scheduling, according to an order of performance in terms of execution time, vector instructions and scalar instructions in the scalar interpolated vectorized loop to generate a scheduled scalar interpolated vectorized loop.

The method may further include unrolling one or more iterations of the vectorized loop to generate an unrolled and scalar interpolated vectorized loop. The method may further include determining a number of iterations of the vectorized loop to unroll based on one or more of: the obtained runtime data, the available scalar resources and available vector resources. The unrolled one or more iterations of the vectorized loop may be based on the determined number of iterations of the vectorized loop to unroll.

The method may further include scheduling, according to an order of performance based on execution time, vector instructions and scalar instructions in the unrolled and scalar interpolated vectorized loop to generate a scheduled unrolled and scalar interpolated vectorized loop.

Determining, based on the obtained runtime data, that scalar interpolation is beneficial to the vectorized loop in terms of resource utilization may include: determining, via a first machine-learned model, that scalar interpolation is beneficial to the vectorized loop in terms of resource utilization. Determining the number of scalar iterations to interpolate into the vectorized loop may include determining, via a second machine-learned model, the number of scalar iterations. Using a machine-learned model to determine the number of scalar iterations may allow for one or both of improved performance and improved utilization of resources. Determining a number of iterations of the vectorized loop to unroll may include determining, via a third machine-learned model, the number of iterations of the vectorized loop to unroll. Using a machine-learned model to determine the number of iterations of the vectorized loop to unroll may allow for one or both of increased performances and improved utilization of resources. The third machine-learned model may be different from or same as the second machine-learned model. Scheduling, according to an order, vector instructions and scalar instructions may include scheduling, via a fourth machine-learned model, the vector instructions and scalar instructions. Using a machine-learned model to schedule the vector instructions and scalar instructions may allow for one or both of improved performance and improved resource utilization. The fourth machine-learned model may be different from or same as the third machine-learned model.

According to another aspect, a method may be provided for balancing computing resources. The method includes generating multiple versions of a vectorized loop. The method may further include interpolating one or more scalar iterations of the vectorized loop into each of the multiple versions of the vectorized loop to generate multiple scalar interpolated vectorized loops. The method may further include selecting one version of the vectorized loop from: the vectorized loop and the multiple scalar interpolated vectorized loops.

The method may further include, for k iterations of the vectorized loop, executing: the vectorized loop, and each of the multiple scalar interpolated vectorized loops. The vectorized loop may terminate at n^{th} iteration, and n may be greater than k. The method may further include measuring execution time, based on the k iterations, for each of: the vectorized loop, and multiple scalar interpolated vectorized loops. Selecting one version of the vectorized loop may be based on the measured execution time.

The method may further include obtaining runtime data of the vectorized loop. The method may further include determining that scalar interpolation is legal for the vectorized loop based on the obtained runtime data.

According to another aspect, an apparatus is provided. The apparatus includes modules configured to perform one or more of the methods and systems described herein.

According to one aspect, an apparatus is provided, where the apparatus includes: a memory, configured to store a program; a processor, configured to execute the program stored in the memory, and when the program stored in the memory is executed, the processor is configured to perform one or more of the methods and systems described herein.

According to another aspect, a computer readable medium is provided, where the computer readable medium stores program code executed by a device and the program code is used to perform one or more of the methods and systems described herein.

According to one aspect, a chip is provided, where the chip includes a processor and a data interface, and the processor reads, by using the data interface, an instruction stored in a memory, to perform one or more of the methods and systems described herein.

Other aspects of the disclosure provide for apparatus, and systems configured to implement the methods according to the first aspect disclosed herein. For example, wireless stations and access points can be configured with machine readable memory containing instructions, which when executed by the processors of these devices, configures the device to perform one or more of the methods and systems described herein.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates an example of code transformations performed by a compiler in Reduced Instruction Set Computer (RISC)-like pseudo-code in a program loop.

FIG. 2 illustrates an example of a processor architecture with distinct processing lanes for the scalar instructions and SIMD instructions.

FIG. 3 illustrates examples of compiler-generated conventional vectorization, ‘vloop’, and selective vectorization, ‘vloop_sel’, from a scalar loop, ‘loop’.

FIG. 4 illustrates example code for conventionally vectorized loop, ‘vloop’, of a scalar loop, ‘loop’, and a compiler transformation based on scalar interpolation, ‘vloop_si’, according to an aspect.

FIG. 5 illustrates a method of scalar interpolation during static compilation, according to an aspect.

FIG. 6 illustrates a method of scalar interpolation in profile or feedback driven optimization, according to an aspect.

FIG. 7 illustrates a method of scalar interpolation using machine-learned models, according to an aspect.

FIG. 8 illustrates a method of scalar interpolation using auto-tuning optimization, according to an aspect.

FIG. 9 illustrates an example of applying Superword-Level Parallelism (SLP) vectorization to a code amenable for vectorization.

FIG. 10 illustrates example code showing conventional SLP vectorization, ‘after-slp’, and SLP vectorization with scalar interpolation, ‘after-slp-si’, applied to a scalar code, ‘before-slp’, according to an aspect.

FIG. 11 illustrates a method for balancing computing resources, according to an aspect.

FIG. 12 illustrates another method for balancing computing resources, according to an aspect.

FIG. 13 illustrates another method for balancing computing resources, according to an aspect.

FIG. 14 illustrates an apparatus that may perform any or all of operations of the above methods and features explicitly or implicitly described herein, according to different aspects of the present disclosure.

It will be noted that throughout the appended drawings, like features are identified by like reference numerals.

### DETAILED DESCRIPTION

Methods and systems for balancing computing resources are described. In some aspects, methods and systems relate to scalar interpolation to balance issue-slot utilization of dynamically scheduled processors with vector units. According to an aspect, a method 1100 may balance computing resources, e.g., processor resources, during static compilation. The method 1100 may include generating 1101 multiple vectorized loops of a scalar code. The method may further include interleaving 1102 each of the multiple vectorized loops to generate multiple interleaved vectorized loops. The interleaving may be based on available vector resources. The method may further include interpolating 1103 one or more scalar iterations of the scalar loop into each of the multiple interleaved vectorized loops to generate multiple interleaved and scalar interpolated vectorized loops. The method may further include selecting 1104 one of the multiple interleaved and scalar interpolated vectorized loops based on a cost model.

According to another aspect, a method 1200 may balance computing resources e.g., processor resources, based on feedback or profiling information obtained during program execution. The method 1200 may include obtaining 1201 runtime data of a vectorized loop. The method may further include interpolating 1202, based on the obtained runtime data, one or more scalar iterations of the vectorized loop into the vectorized loop to generate a scalar interpolated vectorized loop.

According to another aspect, a method 1300 may include generating 1301 multiple versions of a vectorized loop. The method may further include interpolating 1302 one or more scalar iterations of the vectorized loop into each of the multiple versions of the vectorized loop to generate multiple scalar interpolated vectorized loops. The method may further include selecting 1303 one version of the vectorized loop from: the vectorized loop and the multiple scalar interpolated vectorized loops.

Many programs exhibit both data level parallelism (DLP) and instruction level parallelism (ILP). A code exhibits DLP when a single operation can be applied to multiple consecutive data simultaneously. A code exhibits ILP when multiple different independent instructions can be scheduled simultaneously. Modern compilers and processors exploit these program behaviors to improve performance. Modern processors contain specialized resources to handle single-instruction multiple-data (SIMD) instructions that are used to compute code exhibiting DLP. Modern high-performance processors are also able to dynamically schedule and issue multiple instructions simultaneously to exploit ILP. On the software side, compilers generate code that is executed on these processors. Compilers contain multiple code-transformation passes, and some of these passes generate SIMD instructions. Compilers can further optimize code by generating longer instruction windows to enable the processor to schedule dynamically, which allows the processor to maximize ILP. A loop-vectorization pass is an example of a pass that generates SIMD instructions. Passes that perform loop unrolling and loop iteration interleaving are examples of passes that generate longer instruction windows.

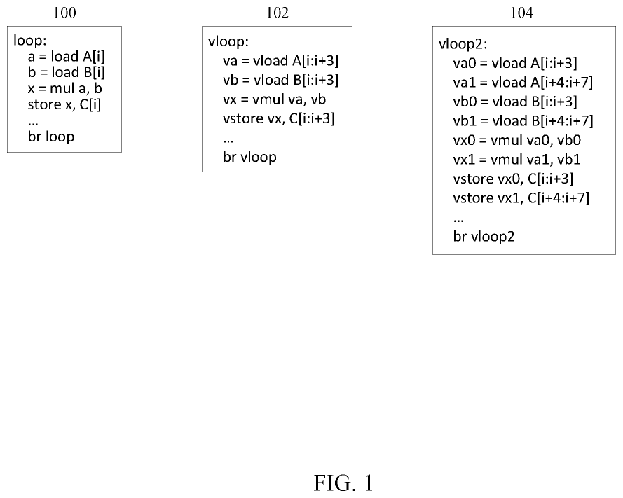

FIG. 1 illustrates an example of code transformations performed by a compiler in Reduced Instruction Set Computer (RISC)-like pseudo-code in a program loop. Referring to code 100, the statements that appear below the ‘loop’ label are scalar computations. In a scalar computation a single instruction operates on a single data value. This loop code 100 multiplies a value stored at A[i] and a value stored at B[i] and stores the result at C[i]. Referring to code 102, the code under label ‘vloop’ is a vectorized version of ‘loop’ in code 100. This vectorization is created by replacing scalar instructions with SIMD instructions. The ‘vloop’ code 102 performs the same computation that the loop code 100 performs. However, vloop processes four data elements of the vector in each loop iteration to take advantage of DLP. This example assumes a processor architecture with a vector width of four elements. The increase in data processing throughput can yield better performance compared to the original scalar loop. The compiler can further optimize the code to exploit ILP by unrolling the loop and interleaving loop iterations as shown in ‘vloop2’ code 104. This transformation unrolls ‘vloop’ by a factor of two, and the instructions of the unrolled iterations are interleaved to place independent instructions adjacently. The processor is then able to schedule and execute the independent instructions in the same clock cycle. This transformation 104 capitalizes on ILP to gain further performance improvements in comparison with both the scalar ‘loop’ 100 and the only vectorized-only ‘vloop’102.

As may be appreciated, scalar and vector processing operations may be executed in separate units, which are treated as separate resources, in modem processor architectures.

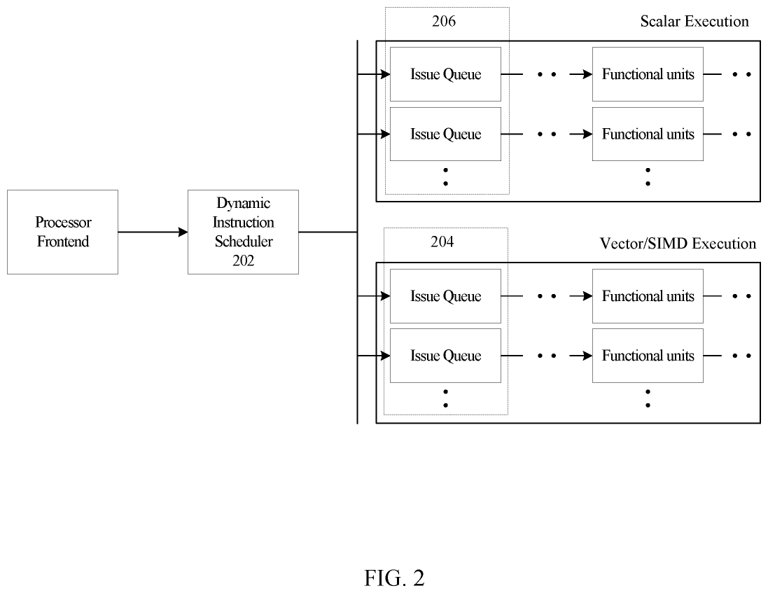

FIG. 2 illustrates an example of a processor architecture with distinct processing lanes for the scalar instructions and SIMD instructions. Instructions ready for execution by the processors instruction scheduler 202 may be buffered in the issue queues prior to execution. SIMD instructions may be buffered in the SIMD issue queues 204 and scalar instructions may be buffered in the scalar issue queues 206. In an embodiment, compiler vectorization may transform most, if not all, scalar instructions into SIMD instructions. The number of SIMD instructions generated may be greater than the original scalar code, especially if one or both of unrolling and interleaving transformations are used to expose ILP.

Vectorization applied at compilation time may result in performance gains by making use of DLP and ILP. However, the large number of SIMD instructions to process at runtime can cause the SIMD issue queues 204 to become full, causing the processor to stall until some of the SIMD instructions can be issued. This happens when the rate of instructions to be buffered in the issue queue is higher than the rate of instructions being drained from the issue queue to be processed by the functional units. Processor stalls due to full issue queues limits performance of the code. Furthermore, when most of the computations in a loop code are converted to SIMD instructions, the SIMD issue queues 204 and subsequent vector resources may be over utilized to execute vectorized code, and at the same time the scalar resources are nearly idle because there are few or no scalar instructions to be executed in the code after vectorization by the compiler.

Accordingly, conventional compiler vectorization of processor architecture may suffer from inefficiencies, including: the over-utilization of SIMD resources in vectorized code causes processor stalls, limiting performance; and the under-utilization of scalar resources of the processor in vectorized code.

Some existing techniques for compiler code transformation are based on applying vectorization selectively to certain instructions in a loop, and then applying software pipelining (modulo scheduling) to the loop to generate static scheduling of instructions.

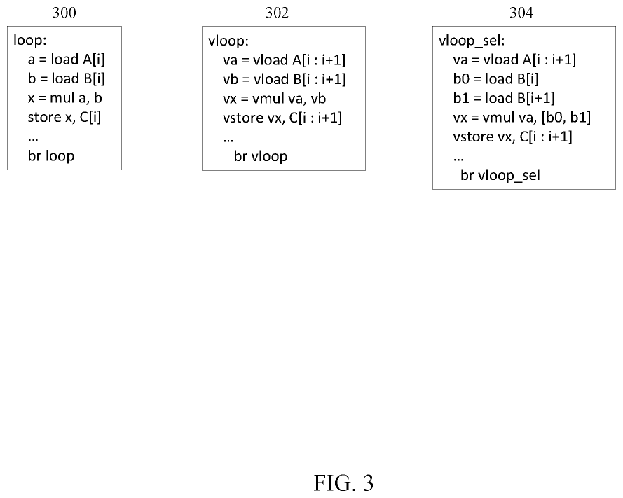

FIG. 3 illustrates examples of compiler-generated conventional vectorization, ‘vloop’, and selective vectorization, ‘vloop_sel’, from a scalar loop, ‘loop’. FIG. 3 shows RISC-like code that applies conventional vectorization 302 and selective vectorization 304 on a scalar loop, ‘loop’, 300. Conventional vectorization 302 applies vectorization to all amendable scalar instructions in a code region, ‘vloop’. Selective vectorization 304, in contrast, only vectorizes a subset of the amenable scalar instructions. The code in ‘vloop_sel’ 304 shows selective vectorization applied to the scalar code in ‘loop’. The original load from A[i] is selectively vectorized whereas the load from B[i] is kept scalar. The dependent multiply and store instruction are selectively vectorized in this example. The loop is vectorized by a factor of two where the SIMD instructions process two consecutive data elements simultaneously. Thus, two consecutive scalar loads B[i] and B[i+1] are needed to match the dependent SIMD instructions.

Existing solutions suffer from a number of limitations. Existing solutions may not be feasible for dynamically scheduled out-of-order processors. For example, software pipelining (module scheduling) of a loop may require a detailed model of the processor to generate an optimal static scheduling of instructions for the loop. This approach, while may be feasible for simple statically scheduled in-order processors, is difficult for complex out-of-order processors since the instruction are scheduled dynamically by the processor itself

Existing solutions may assume that an instruction can have both vector and scalar operands, such the instruction vx=vmul va, [b0, b1] in ‘vloop_sel’ code 304, where a vector operand ‘va’ is multiplied elementwise with scalar operands b0 and b1. However, most processors have separate in-processor data storage (or separate memory locations) to store scalar values and vector values, and thus, they may not support instructions that operate on mixed types. Therefore, selective vectorization may require additional register moves between scalar and vector registers for it to be practically feasible. The register moves can incur considerable overhead on the execution of the loop.

Existing solutions may be limited to short vector architectures (small number of elements in the vector). For example, selective vectorization may require duplicating the scalar code to match the vectorization width of the loop. Architectures that support long vectors may cause selective vectorization to produce excess scalar instructions leading to high register pressure (overutilization of the registers) on scalar registers. High register pressure can cause performance degradations.

According to an aspect, use of processor resources (vector or SIMD resources and scalar resources) may be improved. For example, over-utilization of vector or SIMD resources of the processor may be ameliorated during execution of compiler vectorized code, thereby, reducing the likelihood of processor stalls. Further, under-utilization or idle scalar resources of the processor may be ameliorated during execution of compiler vectorized code.

According to an aspect, a compiler transformation may be provided that interpolates scalar iterations of a loop into a vector loop. The interpolation of scalar code into a vector loop may offload useful work onto the processor scalar resources while reducing the over-utilization of vector resources, and hence reducing processor cycles wasted due to stalls.

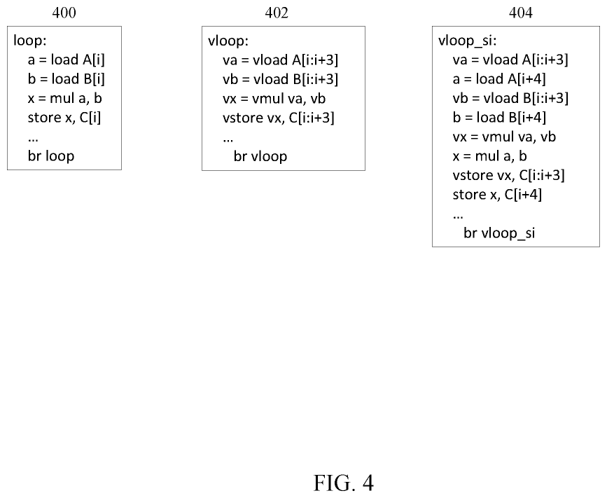

According to an aspect, scalar interpolation may be performed where scalar iterations of a loop are interpolated into a vectorized version of a loop. FIG. 4 illustrates example code for conventionally vectorized loop, ‘vloop’, of a scalar loop, ‘loop’, and a compiler transformation based on scalar interpolation, ‘vloop_si’, according to an aspect. Code 400 is an untransformed and un-optimized scalar loop, ‘loop’. The code 400 may be transformed to code 402, ‘vloop’ code, based on a conventional compiler loop vectorization applied to the scalar loop, ‘loop’ 400.

The conventional loop vectorization, referring to code 402, determines that it is legal to vectorize the loop and transforms the scalar instruction to SIMD instructions to exploit DLP. In the ‘vloop’ example 402, the compiler has vectorized the ‘loop’ by a factor of four—four consecutive elements are processed per SIMD instructions. Thus, each loop iteration of ‘vloop’ is equivalent to four iterations of the original scalar loop, ‘loop’. The code ‘vloop_si’ shows scalar interpolation applied on top of a conventionally vectorized loop, ‘vloop’.

According to an aspect, a scalar iteration of the ‘loop’ may be interpolated into the vectorized loop, ‘vloop’, to generate the code shown in ‘vloop_si’ 404. Thus, a single iteration of ‘vloop_si’ 404 is equivalent to five iterations of the original scalar loop, ‘loop’—the first four iterations are completed through the SIMD instruction sequence, and the fifth iteration is completed by the interpolated scalar iteration. It should be appreciated that the ‘vloop_si’ 404 example only shows one scalar iteration interpolated into one or both of non-unrolled and non-interleaved vector loop for simplicity. In some embodiments, scalar interpolation may interpolate an arbitrary number of scalar iterations into one or both of an unrolled and interleaved vector loop by an arbitrary amount.

By interpolating scalar iterations into vectorized loop, the otherwise idle scalar resource of the processor may be used while the vector resources may be fully utilized, thereby allowing for improved DLP and ILP. Interpolating scalar iterations, according to one or more aspect, may further provide better performance compared to the conventional techniques and the prior art.

According to one or more aspects, scalar interpolation may apply to the processor architecture illustrated in FIG. 2. Processors that have distinct and non-intersecting subset of resources may have an imbalance of resource utilization for which scalar interpolation, according to one or more aspects, may be used to improve processor performance. Such processors may have one subset that is used to exclusively process scalar instructions, and the other subset that exclusively processes SIMD or vector instructions.

One or more aspects may be implemented in any tools that generates or optimizes executable code for a processor such as compilers and binary optimizers. According to an aspect, a scalar loop may be transformed into a vector loop body comprising a functionally equivalent scalar loop body that is interleaved or interpolated within the vector loop body.

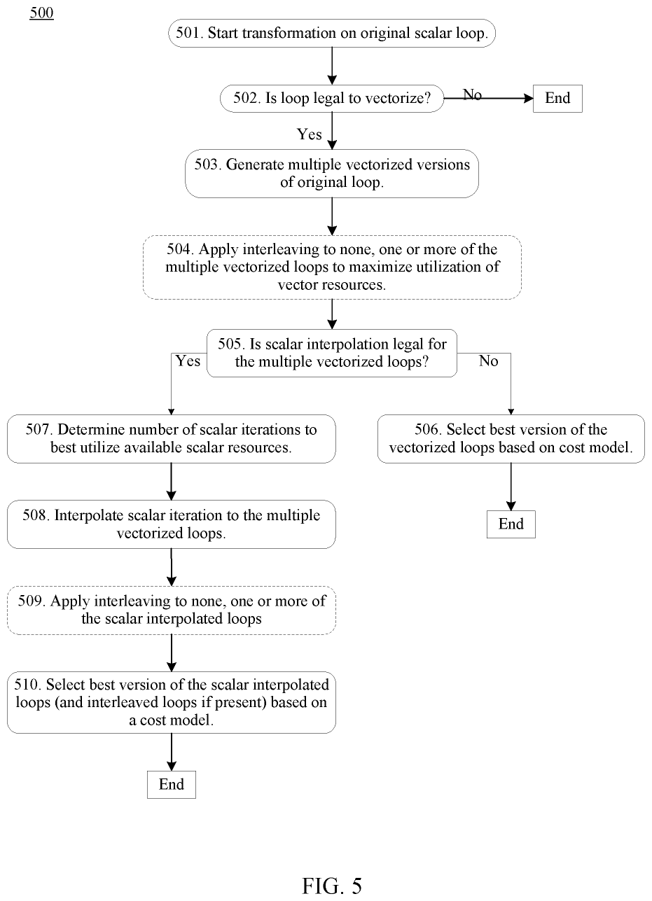

Static compilation is a technique used to compile a program into executable code without information about the run-time behavior of the program. FIG. 5 illustrates a method of scalar interpolation during static compilation, according to an aspect. The method 500 describes the use of scalar interpolation during static compilation of a program. The method 500 is based on applying loop vectorization and scalar interpolation to a scalar loop. The method starts 501 with a scalar loop that is a candidate for loop vectorization and scalar interpolation. The method may further include performing 502 legality checks on the scalar loop to determine if vectorization of the loop is legal, i.e., if vectorization will produce a functionally correct equivalent of the original scalar loop. The legality portion may include, but is not limited to, checking for memory aliasing and cross-iteration loop dependencies. If the loop passes the legality checks, the method further includes vectorizing the loop. There may be more than one way to vectorize a loop that will produce functionally correct code. In some embodiments, the method may include generating 503 multiple legal versions by loop vectorization. If legality checks fail, then neither vectorization nor scalar interpolation is applied to the original loop.

In some embodiments, the method may further include interleaving 504 none, one or more of the multiple vectorized loop versions to maximize ILP by fully utilizing the vector resources in the processing unit. In some embodiments, interleaving 504 may be optional.

The method may further include performing 505 another legality check on the one or more of the vectorized loops and the one or more interleaved vectorized loops (in the case that interleaving 504 was applied) to determine if scalar interpolation is legal. If the legality check determines that scalar interpolation is not legal, then scalar interpolation will not be applied to the vectorized loop versions. The method may then further include, selecting 506 a loop from the one or more of the vectorized loops and the interleaved vectorized loops based on some cost model to replace the original scalar loop. The cost model may be based on one or more of: heuristics that calculate the number of instructions in the loop versions, the latency of the instructions in the loop versions, and ILP present in the loop versions. In some embodiments the cost model may be based on further factors as may be appreciated by person skilled in the art.

For each of the one or more of the loops (vectorized loops and the interleaved vectorized loops), if scalar interpolation is legal, the method may further include determining 507 the number of scalar iterations to interpolate in said each of the one or more of the loops. The optimal number of scalar iterations for each of the one or more of the loops may be a function of, but not limited to, one or more of: the number of scalar resources in the processing unit, the number of scalar instructions that can be issued simultaneously, and the memory alignment of the instructions in the loop.

The method may further include, for each of the one or more of the loops (vectorized loops and the interleaved vectorized loops) that scalar interpolation is legal, interpolating 508 into said each loop the determined number of scalar iterations as determined 507 in said each of the one or more loops. Accordingly, interpolation may add the number of scalar iterations determined in the previous step in the multiple vectorized versions. The method may further include interleaving 509 none, one or more of scalar interpolated loops to further maximize ILP by fully utilizing the vector resources in the processing unit. In some embodiments, interleaving 509 may be optional.

The method may further include selecting 510, based on a cost model, a version of the vectorized loops with scalar interpolation applied based on a cost model. The selection may be made from the one or more of the loops (vectorized loops and interleaved vectorized loops) with scalar interpolation. The cost model may be based on one or more of: heuristics that calculate the number of instructions in the loop versions, the latency of the instructions in the loop versions, and ILP present in the loop versions. In some embodiments the cost model may be based on further factors as may be appreciated by person skilled in the art.

The method 500 may offer simplicity and reduced code generation time. In some embodiments, the parameters for the transformation such as vectorization factor, unrolling and interleaving factor, and the number of scalar iterations to interpolate may be decided by using a static cost model. The quality of the transformation may thus depend on the cost model. The quality of the transformation may further depend on the runtime behavior of the code, which in some cases, may be difficult or impossible for a static model to capture accurately.

According to an aspect, a program may be optimized through one or both of profile and feedback driven optimization. The compiler may use runtime data gathered from execution of the program to make decisions on whether a given code transformation should be applied to the code. The compiler may also use runtime data to determine parameters of the code transformations that should be applied to the code. In some embodiments, profile-driven optimization may yield a better performing executables compared to static compilation.

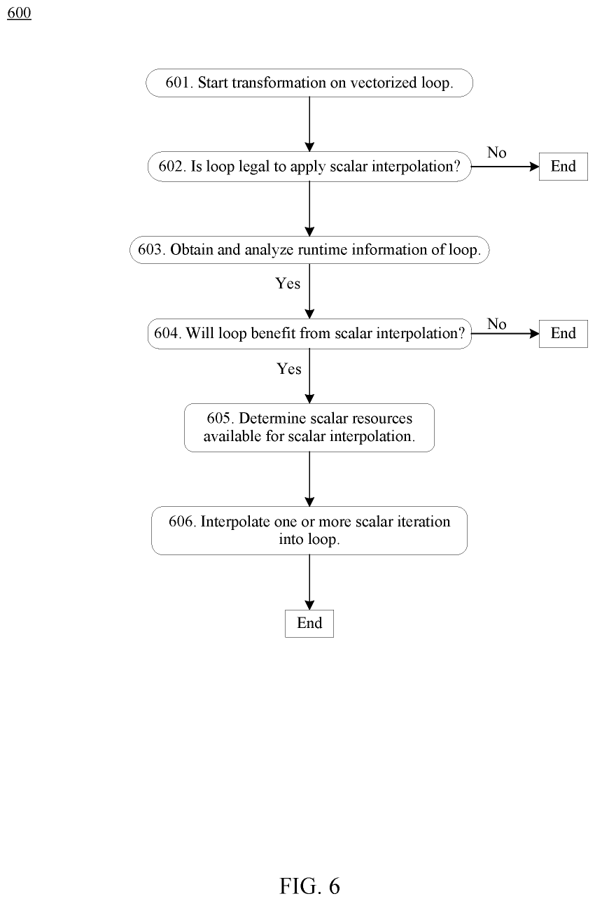

FIG. 6 illustrates a method of scalar interpolation in profile or feedback driven optimization, according to an aspect. The method 600 may be based on applying scalar interpolation onto a vectorized loop, given runtime data. The method begins 601 with an already vectorized loop from a pre-compiled program. In some embodiments, the vectorized loop is generated from an original program being vectorized during the compilation process. In some embodiments, the original program may have scalar loops, and a static compiler may vectorize these loops to generate the “pre-compiled” program. The method 600 may operate on this “pre-compiled” program to add scalar interpolated based on one or both of feedback and profiling information from running the program.

In some embodiments, method 600 may apply to any program that includes a vectorized loop. For example, if a program has no vectorizable code at all, then method 600 will not start since it doesn't have a vectorized loop to begin with. If method 800 discovers a vectorized loop in the program, then the method 600 may apply.

In some embodiments, additional code transformations may be required before the method is applied. For example, one or more loop transformation passes may be done to simplify or optimize the code in the loop to make it more amenable to vectorization and also scalar interpolation.

In some embodiments method 600 can be applied in addition to or after method 500. For example, the vectorized loop at 601 may refer to the selected 510 loop of method 500.

The method may further include performing 602 a legality phase to determine whether scalar interpolation is legal to apply on the vectorized loop. If not, the method ends, and no scalar interpolation is applied. If scalar interpolation is legal, the method may further include obtaining and analyzing 603 runtime data or information of the vectorized loop to determine if there are performance advantages to applying scalar interpolation. For example, the runtime data gathered from executing the program may be inputted into the compiler. The method may further include determining 604 whether scalar interpolation is beneficial to the vectorized loop based on data obtained and analyzed 603. In some embodiments, determining whether scalar interpolation is beneficial to the vectorized loop may include determining 605 scalar resources available for scalar interpolation. The data obtained 602 may include, but is not limited to, data from the hardware performance counters of a processor, which measure the utilization of resources in the processor. If the cost analysis, referring to the determination 604, indicates that scalar interpolation is not beneficial, then the method does not apply the transformation and terminates. If scalar interpolation is deemed to be beneficial, the method may further include determining the number of scalar iterations of the vector loop to interpolate into the loop based on input data obtained 202. The number of interpolated iterations may depend on the utilization balance between the scalar and vector resources of the processor. Based on the determined 605 number of scalar iteration, the method may further include applying 606 the transformation where equivalent scalar iterations of the vector loop is generated and interpolated into the vector loop.

In method 600 the runtime behavior may be captured before applying the scalar interpolation transformation. Accordingly, in some embodiments, method 600 may result in a better performing code compared to method 500 which relies on a static cost model that is unaware of the program runtime behavior.

As may be appreciated, the program needs to be compiled and executed first to generate 602 the runtime information or behavior of the loop. The method 600 may be sensitive to program input, and depending on the program input, a same program may have different runtime behavior. For example, one input set to a program may result in a different runtime behavior from a different input set. Thus, in some embodiments, the method may further include generating multiple versions of the loop code and selecting the most performant version for each input set. The most performant version can be selected by, but not limited to, measuring the resource utilization of the processor through hardware performance counters, measuring latency of the loop and measuring instruction throughput of the loop.

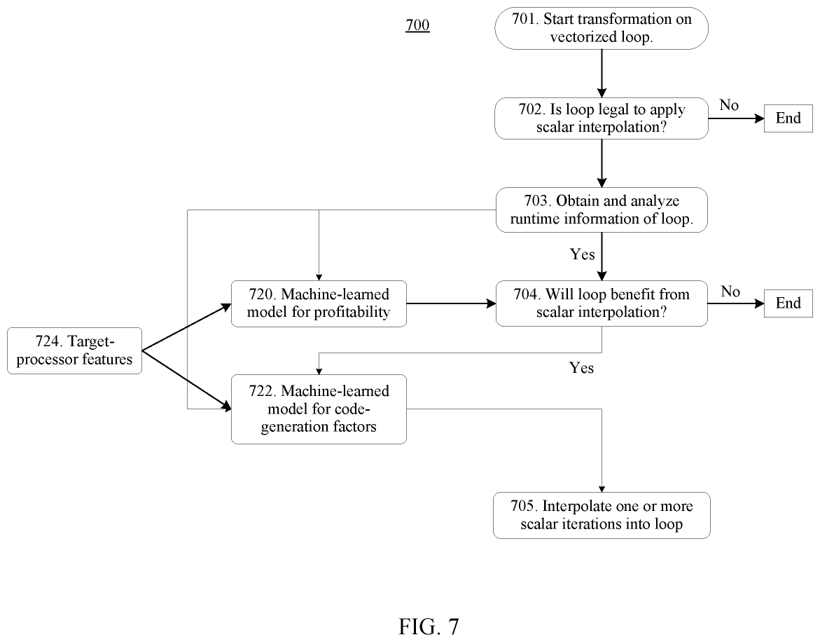

FIG. 7 illustrates a method of scalar interpolation using machine-learned models, according to an aspect. Method 700 may use machine-learned modules to determine profitability of scalar interpolation and make decisions on factors for code generation. According to an aspect, a machine-model model 720 may be used to determine if a vectorized loop will benefit from scalar interpolation.

Method 700 begins 701 with an already vectorized loop from a pre-compiled program. In some embodiments, the vectorized loop is generated from an original program being vectorized during the compilation process. In some embodiments, the original program may have scalar loops, and a static compiler may vectorize these loops to generate the “pre-compiled” program. The method 700 may operate on this “pre-compiled” program to add scalar interpolated based on one or both of feedback and profiling information from running the program.

In some embodiments, method 700 may apply to any program that includes a vectorized loop. For example, if a program has no vectorizable code at all, then method 700 will not start since it doesn't have a vectorized loop to begin with. If method 700 discovers a vectorized loop in the program, then the method 700 may apply.

In some embodiments, additional code transformations may be required before the method is applied. For example, one or more loop transformation passes may be done to simplify or optimize the code in the loop to make it more amenable to vectorization and also scalar interpolation.

In some embodiments method 700 can be applied in addition to or after method 500. For example, the vectorized loop at 701 may refer to the selected 510 loop of method 500.

The method may further include performing 702 a legality check to determine whether scalar interpolation is legal to apply on the vectorized loop. If not, the method ends, and no scalar interpolation is applied. If scalar interpolation is legal, the method may further include obtaining and analyzing 703 runtime data or information of the vectorized loop to determine if there are performance advantages to applying scalar interpolation as determined at 704. For example, the runtime data gathered from executing the program may be inputted into the compiler. the method may further include determining 704 whether scalar interpolation is beneficial to the vectorized loop based on data obtained and analyzed 702. In some embodiments, determining 704 whether scalar interpolation is beneficial to the vectorized loop may be done via a machine-learned model 720. Data obtained 702 may be fed into the machine-learned module 720 to determine 704 profitability of scalar interpolation.

Accordingly, once the machine-learned model 720 is built, at compilation time, the method may include consulting the machine-learned model 720 for profitability in order to make the decision 704 about applying scalar interpolation. The method may further include consulting one or more machine-learned model for code generation 722 to determine one or more parameters for code generation. The data obtained 702 may also be fed into the one or more machine-learned models 722 for determining the one or more parameters for code generation. For example, the compiler code generator may consult the machine-learned model for code generation 722 to determine the factors (the one or more parameters) for code generation.

In some embodiments, the target processor features 724 may be used as input to each of the machine-learned models 720 and 722 used to make decisions according to method 700. Target processor features may include, but are not limited to, the number of scalar processing resources, the number of vector processing resources, the latency and throughput of each scalar and vector instruction.

According to an aspect, one or more machine-learned model 722 may be used to determine one or more parameters for generating code of a vectorized loop with scalar interpolation. The one or more parameters may include a loop unrolling factor. The loop unrolling factor may determine how many iterations of the loop should be unrolled to create a suitable amount of computation to keep the vector and the scalar units efficiently utilized without creating detrimental register pressure. The one or more parameters may further include a scalar interpolation factor, which determines how many scalar computations should be interpolated in the loop to utilize the scalar units in a processor. The one or more parameters may further include an instruction scheduling, which determines the order in which the vector and scalar instructions should appear in the generated code to improve performance (e.g., execution time).

The machine-learned model 720 and 722 may be built by defining a set of features extracted from loop nests and a set of features that describe the relevant portions of processor architectures. The examples used to train the machine-learned model may be from a large collection of relevant programs and from synthetically constructed program examples to cover a larger space of possible programs for which code could be generated. The processor features (e.g., target processor features 724) used to train the machine-learned models may come from a wide range of possible designs of architectures for vector and scalar units, and may not be limited to existing architectures.

In some embodiments, a single machine-learned model 722 may be used to make the decisions (e.g., determining the one or more parameters for generating code of a vectorized loop with scalar interpolation). In some embodiments, more than one machine-learned model 722 may be used to determine the one or more parameters for generating code of a vectorized loop with scalar interpolation. In some embodiments, a separate machine-learned model 722 may be used for determination of each parameter of the one or more parameters.

The method may further include, interpolating 705 one or more scalar iterations into the vectorized loop according based on the outcome of the one or more machine-learned model 722.

According to an aspect, the method 700 may obviate the need to design and tune equations for either the decision 704 about the profitability of applying scalar interpolation or the scalar interpolation factors 722 used for the code generation because these decisions are made by the machine-learned model.

As may be appreciated, the method 700 may require building the machine-learned models 720 and 722, including the need to create an adequate training set with samples of both possible computer programs and relevant processor architecture design. The cost in design time, processing time, and energy consumption for the creation of the machine-learned models may be non-trivial. The method 700 may further need to run inference in the machine-learned model during code generation time.

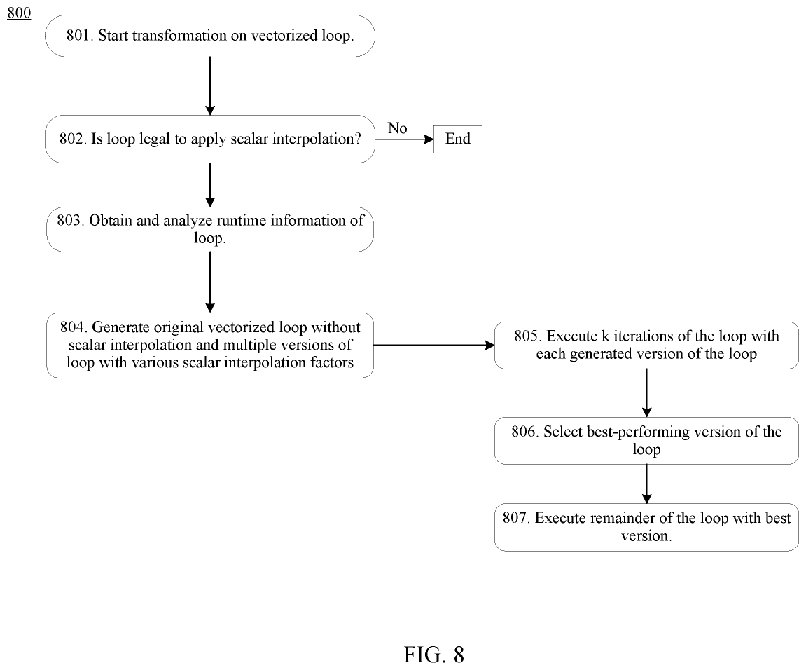

FIG. 8 illustrates a method of scalar interpolation, according to an aspect. Method 800 is an auto-tunning method where the compiler generates multiple versions of the vectorized loop, and each of the multiple versions are run, at runtime, for k iterations of the vectorized loop. After k iterations, the best-performing version is selected to execute the remaining of the loop.

Method 800 begins 801 with an already vectorized loop from a pre-compiled program. In some embodiments, the vectorized loop is generated from an original program being vectorized during the compilation process. In some embodiments, the original program may have scalar loops, and a static compiler may vectorize these loops to generate the “pre-compiled” program. The method 800 may operate on this “pre-compiled” program to add scalar interpolated based on one or both of feedback and profiling information from running the program.

In some embodiments, method 800 may apply to any program that includes a vectorized loop. For example, if a program has no vectorizable code at all, then method 800 will not start since it doesn't have a vectorized loop to begin with. If method 800 discovers a vectorized loop in the program, then the method 800 may apply.

In some embodiments, additional code transformations may be required before the method is applied. For example, one or more loop transformation passes may be done to simplify or optimize the code in the loop to make it more amenable to vectorization and also scalar interpolation.

In some embodiments method 800 can be applied to after method 500. For example, the vectorized loop at 801 may refer to the selected 510 loop of method 500.

The method may further include performing 802 a legality check to determine whether scalar interpolation is legal to apply on the vectorized loop. If not, the method ends, and no scalar interpolation is applied. If scalar interpolation is legal, the method may further include obtaining and analyzing 803 runtime data or information about the vectorized loop to determine if there are performance advantages to applying scalar interpolation. For example, the runtime data gathered from executing the program may be inputted into the compiler. The method may further include generating 804 original vector loop in the pre-compiled program without scalar interpolation and multiple versions of the loop with various scalar interpolation factors. Thus, one version does not use scalar interpolation and the other versions use various amounts of scalar interpolation.

As may be appreciated, in method 800, the generating 804 operations are performed instead of: determining whether the loop will benefit from scalar interpolation (e.g., 604 in reference to method 600 and 704 in reference to method 700) and determining the scalar resources and the amount of scalar interpolation (e.g., 605 in reference to method 600 and 705 in reference to method 700).

The method may further include, at execution time, for each of the versions of the loop generated, executing 805 k iterations of the loop. The execution time for executing the k iterations may be measured. The value of k may be an implementation parameter that can be determined through experimentation.

The method may further include, selecting 806, at runtime, the best-performing version of the loop (e.g., the loop with the shortest execution time, or other performance criteria as may be appreciated by a person skilled in the art) for the processor where the code is being executed. The method may further include executing 807 the remainder of the loop using the selected best-performing version of the loop. As may be appreciated, in method 800, performance advantage may be measured or determined by running the loop for “k” iterations of each of the versions of the loop generated 804. Then the best performing version may be selected for execution.

Thus, the best loop is chosen by executing “k” iterations of the different versions of the loop. If the loop is not beneficial for scalar interpolation, running the “k” iteration may indicate that the version of the loop without scalar interpolation performs the best in which the method may allow for the loop without scalar interpolation be selected 806 to continue to execution.

The method 800 may require an effective and efficient way to precisely measure the execution time of the k iterations of the loop. The method 800 may be independent of the processor architecture design. The method 800 may be adaptable to multiple processor designs because the decision about the scalar interpolation factor is not specific for a given processor architecture design.

It may be appreciated that method 800 may incur some additional overhead due to code generation 804, executing 805 the multiple versions of the loop, and selecting 806 the best-performing version. This overhead may be reduced with estimations made at compilation time to reduce the number of versions of the loop to be generated 804.

According to an aspect, scalar computation may be interpolated in a vectorized loop. Scalar interpolation may allow for improved utilization of processor resources because the scalar-computation resources are not idle while executing a vectorized loop. Accordingly, a faster overall time for the execution of the loop may be achieved.

According to an aspect, determining when scalar interpolation may be legal is described in one or more methods herein. Determining when scalar interpolation may be legal may prevent the generation of incorrect code. According to an aspect, determining when scalar interpolation is advantageous or profitable is described in one or more methods herein. Determining when scalar interpolation is advantageous may prevent the generation of code that is less performant than the traditional vectorized code for a loop.

According to an aspect, decisions on whether scalar interpolation is legal and applying said scalar interpolation may be done at runtime. Making these decisions at runtime may allow for a more versatile and readily applicable code transformation method for newer processor architectures because there may be no need to change the decision process used in the compiler.

According to an aspect, multiple versions of a vectorized loop may be generated and the most performant of said multiple versions may be selected to execute the code. The selection can be made either statically at compile time or at runtime. Selecting the most performant loop version at runtime may be advantageous since the selection may be based on actual values, such as the actual trip count of the loop and the parameters of the processor architecture. In some embodiments, the runtime decision (e.g., selecting at runtime) may use a just-in-time-compilation method where an analytical model is used to select the best loop version based on the values discovered at runtime. In some embodiments, the runtime decision may use an autotuning method where the various alternatives are run, each for a relatively short number of loop iterations, their execution time is measured, and then the best one is selected.

Although one or more aspects are described in the context of compiler loop vectorization (where the compiler applies vectorization to loops identified in the program), the one or more aspects may also apply to straight-line code (code that does not have to exist in loops). According to an aspect, a compiler transformation pass may apply vectorization to a straight-line code. Applying vectorization to straight-line code may be referred to as Superword-Level Parallelism (SLP) vectorization. SLP vectorization may identify independent, isomorphic instructions in straight-line code and replace the instructions with equivalent SIMD instructions.

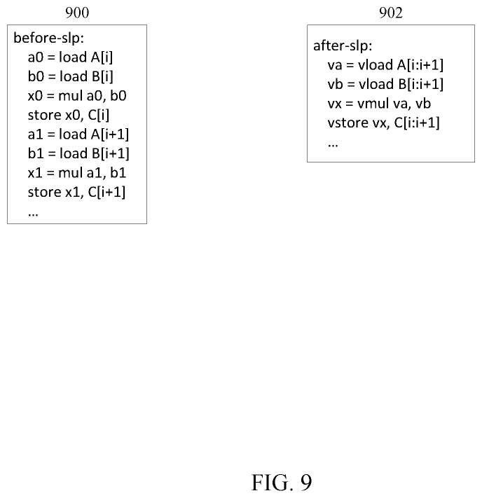

FIG. 9 illustrates an example of applying Superword-Level Parallelism (SLP) vectorization to a code amenable for vectorization. Code 900 is independent and isomorphic instructions amenable for vectorization, ‘before-slp’. Code 902 is a code based on applying SLP vectorization, ‘after-slp’, to code 900. Scalar loads from A[i] and A[i+1] access consecutive data and can be expressed as a single SIMD load accessing two elements. The same transformation can be applied to scalar loads from B[i] and B[i+1]. The subsequent multiply and store instructions can also be expressed as SIMD instructions. The resultant code after SLP vectorization is shown in ‘after-slp’ code 902.

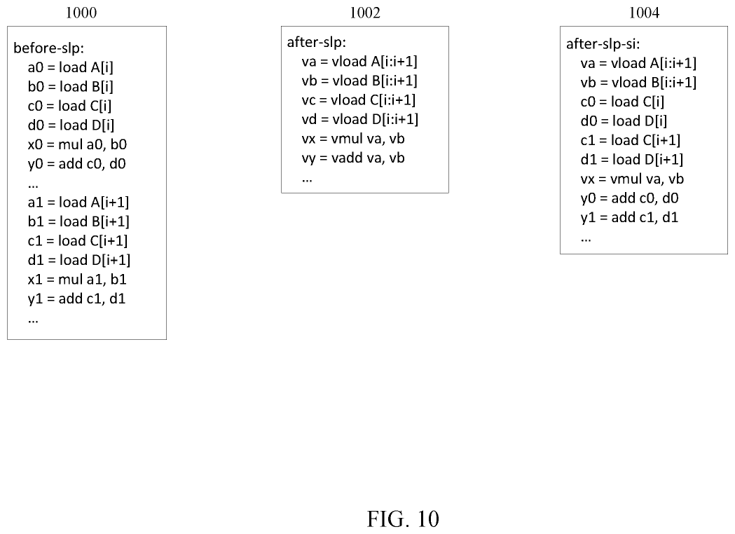

FIG. 10 illustrates example code showing conventional SLP vectorization, ‘after-slp’, and SLP vectorization with scalar interpolation, ‘after-slp-si’, applied to a scalar code, ‘before-slp’, according to an aspect.

Code 1000 is a straight-line code which may be transformed using conventional SLP vectorization. Conventional SLP vectorization, ‘after-slp’ 1002 applies vectorization to all amenable instruction in scalar code, ‘before-slp’. The abundance of SIMD instructions generated from SLP vectorization may cause over-utilization of vector resources, and under-utilization of scalar resources. Scalar interleaving may apply in straight-line code vectorization such as SLP vectorization. According to an aspect, scalar interpolation in the context of SLP vectorization may generate code shown in, ‘after-slp-si’ 1004 where some scalar instructions are not vectorized (i.e., loads from C[i], C[i+1] and D[i], D[i+1] and dependent add instructions) in contrast to conventional SLP vectorization where all amenable instructions are vectorized. As may be appreciated, scalar interpolation applied in SLP vectorization may also achieve the same benefit of balancing processor resource utilization.

According to an aspect, scalar interpolation transformation may be applied through the compiler. In some aspects, application of scalar interpolation, whether static or feedback driven, may require some cost model to determine the number of scalar iterations to interpolate into a vector loop.

In some aspects, the number of scalar iterations to apply may be determined dynamically, at runtime, by the processor. The compiler may generate information used to label vector code as legal for scalar interpolation, which is then communicated to the processor during execution of the program. While the processor is executing the vector code labeled legal for scalar interpolation, the processor can dynamically determine the number of scalar iterations to interpolate into the vectorized code. As may be appreciated, dynamically determining one or more scalar iterations to interpolate can bypass the need for a cost model in static compilation, and complex code generation as in the feedback-driven, machine learning, and auto-tunning methods.

According to one or more aspects, other computing domains may also benefit from the use of scalar instead of vector operations, or mixed with vector operations. For example, when scalar units are available in a graphic processing unit (GPU), they can be used instead of the vector units. In graphics processing, sometimes the input parameters for a given operation may all be identical. In such cases executing a scalar operation instead of performing a SIMD computation can be advantageous in terms of resource utilization and energy consumption. According to an aspect, scalar interpolation may be adapted to apply in the context of GPU. One or more methods described herein in reference to deciding when scalar interpolation is legal and when it is profitable may be adapted to GPU cases.

According to one or more aspects, scalar interpolation may apply in the context of accelerators. Similar to the case of GPUs, in some types of accelerators, such as accelerators designed for ray tracing, executing a scalar operation instead of performing a SIMD computation can be advantageous in terms of resource utilization and energy consumption.

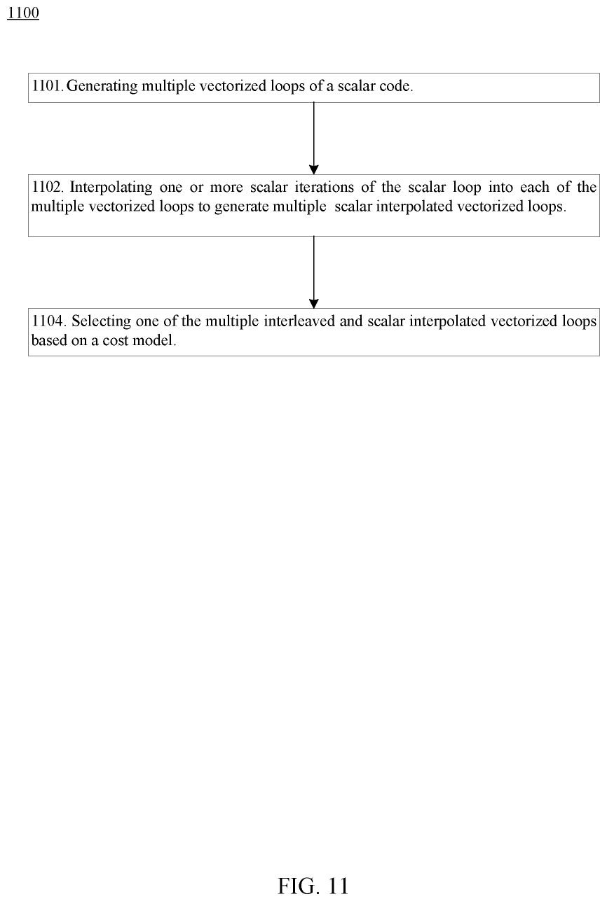

FIG. 11 illustrates a method for balancing computing resources, according to an aspect. The method 1100 may balance computing resources, e.g., processor resources, during static compilation. The method 1100 may include generating 1101 multiple vectorized loops of a scalar code. The method may further include interpolating 1102 one or more scalar iterations of the scalar loop into each of the multiple vectorized loops to generate multiple scalar interpolated vectorized loops. The method may further include selecting 1103 one of the multiple scalar interpolated vectorized loops based on a cost model.

The method may further include determining that the scalar loop is legal to vectorize. The method may further include determining that scalar interpolation is legal for each of the multiple vectorized loops. The method may further include, for each of the multiple vectorized loops, determining a number of scalar iterations to interpolate based on the available scalar resources. The one or more scalar iterations interpolated into each of the multiple vectorized loops may be based on the determined number of scalar iterations.

The cost model may be based on heuristics calculated based on number of instructions in each of the multiple interleaved and scalar interpolated vectorized loops. The cost model may be further based on latency of instructions in each of the multiple interleaved and scalar interpolated vectorized loops. The cost model may be further based on instruction-level parallelism (ILP) present in each of the multiple interleaved and scalar interpolated vectorized loops.

The method may further include interleaving one or more of the multiple vectorized loops to generate one or more interleaved vectorized loops, the interleaving being based on available vector resources.

Interpolating one or more scalar iterations of the scalar loop into each of the multiple vectorized loops to generate multiple scalar interpolated vectorized loops further may include interpolating one or more scalar iterations of the scalar loop into each of the one or more interleaved vectorized loops to generate one or more interleaved and scalar interpolated vectorized loops.

Selecting one of the multiple scalar interpolated vectorized loops based on a cost model may include selecting, based on the cost model, one of: the multiple scalar interpolated vectorized loops and the one or more interleaved and scalar interpolated vectorized loops.

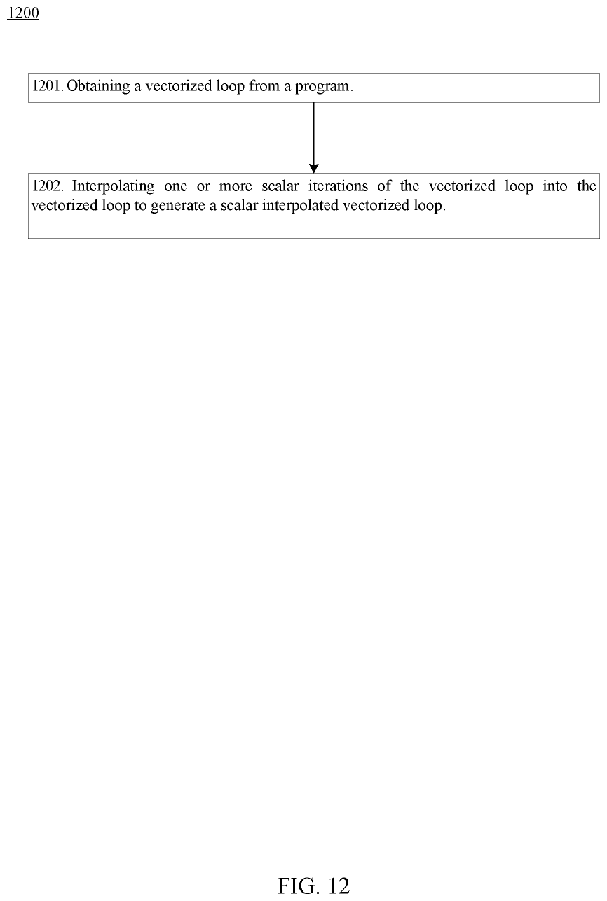

FIG. 12 illustrates another method for balancing computing resources, according to an aspect. The method 1200 may balance computing resources e.g., processor resources, based on feedback or profiling information obtained during program execution. The method 1200 may include obtaining 1201 a vectorized loop from a program. The method may further include interpolating 1202 one or more scalar iterations of the vectorized loop into the vectorized loop to generate a scalar interpolated vectorized loop.

Obtaining the vectorized loop from a program comprises vectorizing the program. The program may be a pre-compiled program. The method may further include determining that scalar interpolation is legal for the vectorized loop. The method may further include obtaining runtime data of the vectorized loop.

The obtained runtime data may be performance data indicating resource utilization. The method may further include determining, based on the obtained runtime data, that scalar interpolation is beneficial to the vectorized loop in terms of resource utilization.

Interpolating one or more scalar iterations of the vectorized loop into the vectorized loop may include interpolating based on the obtained runtime data. Interpolating one or more scalar iterations of the vectorized loop into the vectorized loop may include generating one or more equivalent scalar iterations of the vectorized loop. Interpolating one or more scalar iterations of the vectorized loop into the vectorized loop may further include interpolating the one or more generated equivalent scalar iterations into the vectorized loop.

The method may further include determining the available scalar resources for scalar interpolation. The method may further include determining a number of scalar iterations to interpolate into the vectorized loop based on one or more of: the obtained runtime data and the available scalar resources. The one or more scalar iterations interpolated into the vectorized loop may be based on the determined number of scalar iterations.

The method may further include scheduling, according to an order of performance in terms of execution time, vector instructions and scalar instructions in the scalar interpolated vectorized loop to generate a scheduled scalar interpolated vectorized loop.

The method may further include unrolling one or more iterations of the vectorized loop to generate an unrolled and scalar interpolated vectorized loop. The method may further include determining a number of iterations of the vectorized loop to unroll based on one or more of: the obtained runtime data, the available scalar resources and available vector resources. The unrolled one or more iterations of the vectorized loop may be based on the determined number of iterations of the vectorized loop to unroll.

The method may further include scheduling, according to an order of performance based on execution time, vector instructions and scalar instructions in the unrolled and scalar interpolated vectorized loop to generate a scheduled unrolled and scalar interpolated vectorized loop.

Determining, based on the obtained runtime data, that scalar interpolation is beneficial to the vectorized loop in terms of resource utilization may include: determining, via a first machine-learned model, that scalar interpolation is beneficial to the vectorized loop in terms of resource utilization. Determining the number of scalar iterations to interpolate into the vectorized loop may include: determining, via a second machine-learned model, the number of scalar iterations. Determining a number of iterations of the vectorized loop to unroll may include determining, via a third machine-learned model, the number of iterations of the vectorized loop to unroll. The third machine-learned model may be different from or same as the second machine-learned model. Scheduling, according to an order, vector instructions and scalar instructions may include scheduling, via a fourth machine-learned model, the vector instructions and scalar instructions. The fourth machine-learned model may be different from or same as the third machine-learned model.

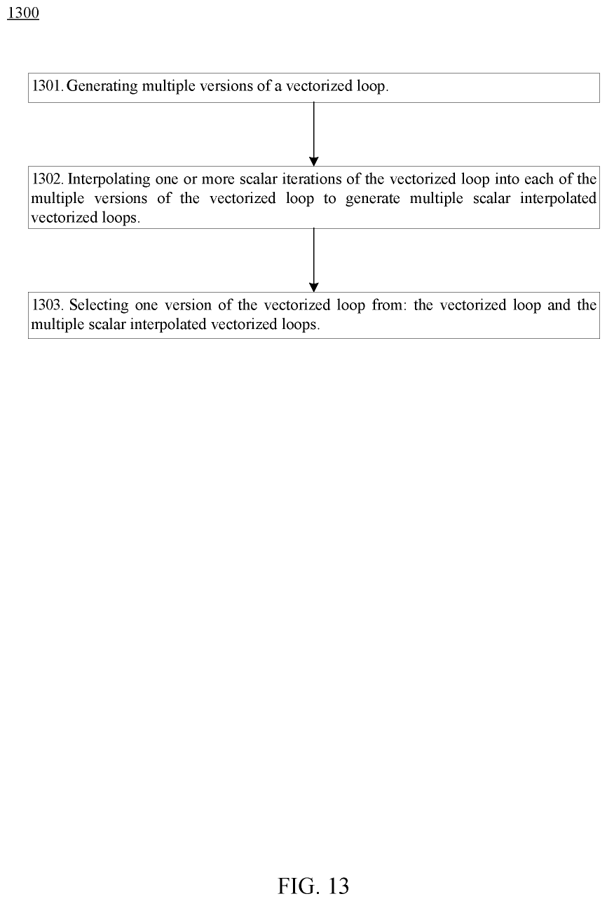

FIG. 13 illustrates another method for balancing computing resources, according to an aspect. The method 1300 may include generating 1301 multiple versions of a vectorized loop. The method may further include interpolating 1302 one or more scalar iterations of the vectorized loop into each of the multiple versions of the vectorized loop to generate multiple scalar interpolated vectorized loops. The method may further include selecting 1303 one version of the vectorized loop from: the vectorized loop and the multiple scalar interpolated vectorized loops.

The method may further include, for k iterations of the vectorized loop, executing: the vectorized loop, and each of the multiple scalar interpolated vectorized loops. The vectorized loop may terminate at n^{th} iteration, and n may be greater than k. The method may further include measuring execution time, based on the k iterations, for each of: the vectorized loop, and multiple scalar interpolated vectorized loops. Selecting one version of the vectorized loop may be based on the measured execution time.

The method may further include obtaining runtime data of the vectorized loop. The method may further include determining that scalar interpolation is legal for the vectorized loop based on the obtained runtime data.

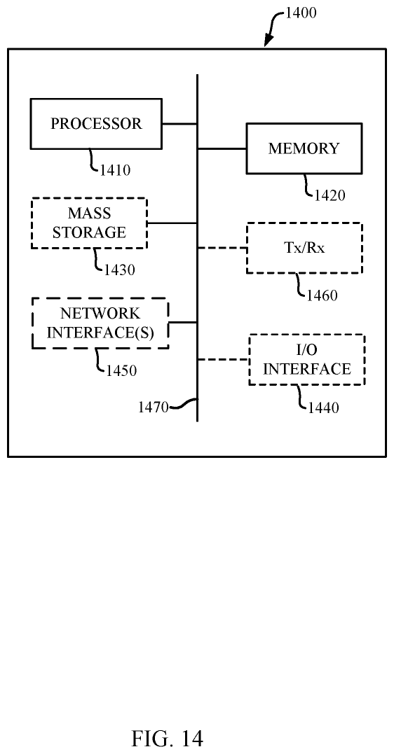

FIG. 14 illustrates an apparatus 1400 that may perform any or all of operations of the above methods and features explicitly or implicitly described herein, according to different aspects of the present disclosure. For example, a computer equipped with network function may be configured as the apparatus 1400. In some aspect, apparatus 1400 can be a device that connects to the network infrastructure over a radio interface, such as a mobile phone, smart phone or other such device that may be classified as user equipment (UE). In some aspects, the apparatus 1400 may be a Machine Type Communications (MTC) device (also referred to as a machine-to-machine (m2m) device), or another such device that may be categorized as a UE despite not providing a direct service to a user. In some aspects, apparatus 1400 may be used to implement one or more aspects described herein. For example, the apparatus 1400 may be a networking device (a router, an edge router, or a switch) configured to implement or perform one or more operations described herein.

As shown, the apparatus 1400 may include a processor 1410, such as a Central Processing Unit (CPU) or specialized processors such as a Graphics Processing Unit (GPU) or other such processor unit, memory 1420, non-transitory mass storage 1430, input-output interface 1440, network interface 1450, and a transceiver 1460, all of which are communicatively coupled via bi-directional bus 1470. According to certain aspects, any or all of the depicted elements may be utilized, or only a subset of the elements. Further, apparatus 1400 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 1420 may include any type of non-transitory memory such as static random-access memory (SRAM), dynamic random-access memory (DRAM), synchronous DRAM (SDRAM), read-only memory (ROM), any combination of such, or the like. The mass storage element 1430 may include any type of non-transitory storage device, such as a solid-state drive, hard disk drive, a magnetic disk drive, an optical disk drive, USB drive, or any computer program product configured to store data and machine executable program code. According to certain aspects, the memory 1420 or mass storage 1430 may have recorded thereon statements and instructions executable by the processor 1410 for performing any of the aforementioned method operations described above.

Aspects of the present disclosure can be implemented using electronics hardware, software, or a combination thereof. In some aspects, this may be implemented by one or multiple computer processors executing program instructions stored in memory. In some aspects, the invention is implemented partially or fully in hardware, for example using one or more field programmable gate arrays (FPGAs) or application specific integrated circuits (ASICs) to rapidly perform processing operations.

It will be appreciated that, although specific aspects of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding aspects, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the aspects of the present invention. For example, such an execution may correspond to a simulation of the logical operations as described herein. The software product may additionally or alternatively include a number of instructions that enable a computer device to execute operations for configuring or programming a digital logic apparatus in accordance with aspects of the present invention.

Although the present invention has been described with reference to specific features and aspects thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method comprising:
generating multiple vectorized loops of a scalar code;
interpolating one or more scalar iterations of the scalar loop into each of the multiple vectorized loops to generate multiple scalar interpolated vectorized loops; and
selecting one of the multiple scalar interpolated vectorized loops based on a cost model.

2. The method of claim 1 further comprising, determining that the scalar loop is legal to vectorize.

3. The method of claim 1 further comprising, determining that scalar interpolation is legal for each of the multiple vectorized loops.

4. The method of claim 1 further comprising:
for each of the multiple vectorized loops, determining a number of scalar iterations to interpolate based on the available scalar resources, wherein the one or more scalar iterations interpolated into each of the multiple vectorized loops is based on the determined number of scalar iterations.

5. The method of claim 1 to wherein the cost model is based on one or more of:
heuristics calculated based on number of instructions in each of the multiple interleaved and scalar interpolated vectorized loops;
latency of instructions in each of the multiple interleaved and scalar interpolated vectorized loops; and
instruction-Level Parallelism (ILP) present in each of the multiple interleaved and scalar interpolated vectorized loops.

6. The method of claim 1 further comprising:
interleaving one or more of the multiple vectorized loops to generate one or more interleaved vectorized loops, the interleaving being based on available vector resources, wherein:
interpolating one or more scalar iterations of the scalar loop into each of the multiple vectorized loops to generate multiple scalar interpolated vectorized loops further comprises: interpolating one or more scalar iterations of the scalar loop into each of the one or more interleaved vectorized loops to generate one or more interleaved and scalar interpolated vectorized loops; and
selecting one of the multiple scalar interpolated vectorized loops based on a cost model comprises selecting, based on the cost model, one of: the multiple scalar interpolated vectorized loops and the one or more interleaved and scalar interpolated vectorized loops.

7. A method comprising:
obtaining a vectorized loop from a program; and
interpolating one or more scalar iterations of the vectorized loop into the vectorized loop to generate a scalar interpolated vectorized loop.

8. The method of claim 7, wherein obtaining the vectorized loop from a program comprises vectorizing the program.

9. The method of claim 7, wherein the program is a pre-compiled program.

10. The method of claim 7 further comprising:
determining that scalar interpolation is legal for the vectorized loop.

11. The method of claim 7 further comprising:
obtaining runtime data of the vectorized loop.

12. The method of claim 11 further comprising: determining, based on the obtained runtime data, that scalar interpolation is beneficial to the vectorized loop in terms of resource utilization, wherein the obtained runtime data is performance data indicating resource utilization.

13. The method of claim 11 wherein interpolating one or more scalar iterations of the vectorized loop into the vectorized loop comprises interpolating based on the obtained runtime data.

14. The method of claim 7 wherein interpolating one or more scalar iterations of the vectorized loop into the vectorized loop comprises:
generating one or more equivalent scalar iterations of the vectorized loop; and
interpolating the one or more of the generated equivalent scalar iterations into the vectorized loop.

15. The method of claim 13 further comprising, determining the available scalar resources for scalar interpolation.

16. The method of claim 15 further comprising:
determining a number of scalar iterations to interpolate into the vectorized loop based on one or more of: the obtained runtime data and the available scalar resources, wherein the one or more scalar iterations interpolated into the vectorized loop is based on the determined number of scalar iterations.

17. The method of claim 7 further comprising:
scheduling, according to an order of performance based on execution time, vector instructions and scalar instructions in the scalar interpolated vectorized loop to generate a scheduled scalar interpolated vectorized loop.

18. The method of claim 7 further comprising:
unrolling one or more iterations of the vectorized loop to generate an unrolled and scalar interpolated vectorized loop.

19. The method of claim 18 further comprising:
determining a number of iterations of the vectorized loop to unroll based on one or more of: the obtained runtime data, the available scalar resources and available vector resources, wherein the unrolled one or more iterations of the vectorized loop is based on the determined number of iterations of the vectorized loop to unroll.

20. The method of claim 18 further comprising: scheduling, according to an order of performance based on execution time, vector instructions and scalar instructions in the unrolled and scalar interpolated vectorized loop to generate a scheduled unrolled and scalar interpolated vectorized loop.

21. The method of claim 12 wherein determining, based on the obtained runtime data, that scalar interpolation is beneficial to the vectorized loop in terms of resource utilization comprises: determining, via a first machine-learned model, that scalar interpolation is beneficial to the vectorized loop in terms of resource utilization.

22. The method of claims 21 wherein determining the number of scalar iterations to interpolate into the vectorized loop comprises: determining, via a second machine-learned model, the number of scalar iterations.

23. The method of claim 22, wherein determining a number of iterations of the vectorized loop to unroll comprises determining, via a third machine-learned model, the number of iterations of the vectorized loop to unroll, wherein the third machine-learned model is different from or same as the second machine-learned model.

24. The method of claim 23 wherein scheduling, according to an order, vector instructions and scalar instructions comprises scheduling, via a fourth machine-learned model, the vector instructions and scalar instructions, wherein the fourth machine-learned model is different from or same as the third machine-learned model.

25. A method comprising:
generating multiple versions of a vectorized loop;
interpolating one or more scalar iterations of the vectorized loop into each of the multiple versions of the vectorized loop to generate multiple scalar interpolated vectorized loops; and
selecting one version of the vectorized loop from: the vectorized loop and the multiple scalar interpolated vectorized loops.

26. The method of claim 25 further comprising:
for k iterations of the vectorized loop, executing:
the vectorized loop; and
each of the multiple scalar interpolated vectorized loops, wherein the vectorized loop terminates at n^{th} iteration and n>k.

27. The method of claim 25 further comprising:
measuring execution time, based on the k iterations, for each of: the vectorized loop, and multiple scalar interpolated vectorized loops.

28. The method of claim 27, wherein selecting one version of the vectorized loop is based on the measured execution time.

29. The method of claim 25 further comprising:
obtaining runtime data of the vectorized loop; and
determining that scalar interpolation is legal for the vectorized loop based on the obtained runtime data.

30. An apparatus comprising:
at least one processor; and
at least one machine-readable medium storing executable instructions which when executed by the at least one processor configure the apparatus to perform the method as described in claim 1.

31. A computer device comprising a non-transitory computer readable medium having instructions stored thereon which, when executed by a computer processor, causes the computer to perform the method as described in claim 1.
